(19) United States
(12) Patent Application Publication
(10) Pub. No.: US 2005/0049988 A1
(43) Pub. Date: Mar. 3, 2005

(54) Provision of data for analysis

(76) Inventors: Erik Dahlquist, Vasteras (SE); Galia Weidl, Steinenbronn (DE); Gerhard Vallmar, Meckenheim (DE); Raiko Milanovic, Heidelberg (DE)

Correspondence Address: VENABLE, BAETJER, HOWARD AND CIVILETTI, LLP, P.O. BOX 34385, WASHINGTON, DC, 20043-9998, US

(21) Appl. No.: 10/845,519

(22) Filed: May 14, 2004

(30) Foreign Application Priority Data
Nov. 16, 2001 (GB) 0127553.6

(51) Int. Cl. G06F 15/00; G06F 15/76; G06N 5/02; G06F 17/00

(52) U.S. Cl. 706/46

(57) ABSTRACT

A method of providing data for root cause analysis. Data is transferred from a structured data model into a causally oriented data model. The causally oriented data model is complemented with information associated with conditional probabilities between at least two objects of the causally oriented data model.

### FIELD OF THE INVENTION

The present invention relates to provision of data for analysis, and in particular, but not exclusively, to provision of data for analysis of at least one possible root cause of an event. The data can be processed by an analyser function of a control system.

### BACKGROUND OF THE INVENTION

A control system is typically used for obtaining efficient and safe operation of a facility and/or for provision of information regarding the facility. To provide these objectives a control system may be adapted to monitor, analyse and manipulate the facility to be controlled by the control system. In a modern control system at least part of the functions is accomplished by data processing means. Different information collecting and other monitoring means (e.g. different sensors, meters and so on) may also be provided. The information may be collected and input into the control system automatically, semi-automatically, or manually.

Examples of the facilities to be controlled by a control system include various industrial facilities. An industrial facility may comprise, for example, a manufacturing facility such as a factory or a similar production unit. An industrial facility may also be for provision of different processes such as continuous, discrete, or batch like processes and so on. Examples of such industrial facilities include, without limiting to these, chemical plants, oil refineries, pharmaceutical or petrochemical industries, food and beverage industries, pulp and paper mills, power plants, steel mills, metals and foundry plants, automated factories and so on. Examples of other facilities that may need to be controlled by a control system include arrangements such as automatic storage systems, automated goods and/or package handling systems, for example, freight handling systems such as airport baggage loading and transfer systems, communication systems, buildings and other constructions, and so on. The term facility shall also be understood to refer to any subsystem e.g. in an industrial plant. A subsystem may be e.g. a manufacturing cell, a machine, a component, a process stage and so on.

A facility may need to be analysed for various reasons. The results of the analysis may be used e.g. as a support in the control of the process, for producing information that is needed later on e.g. when processing an end product of the process, for diagnostic of events such as a fault or abnormality. It is also possible to diagnose complex products or their parts and/or optimise assets by means of process analysis.

The term ‘event’ shall be understood to refer to anything that may occur in the facility during the operation thereof. For example, the event may comprise an abnormality or failure/fault or any other deviation from normal operation conditions of the facility.

Especially in large and/or complex facilities such as the industrial facilities information available for analysing deviations from normal operation conditions such as failures or other abnormalities or events may be incomplete. The domain knowledge or data associated with a facility to be analysed and/or the event domain may also include uncertainties.

Computerised analysers are known. Data to be analysed by a known computerised analyser is organised in a hierarchical data file structure or model. In a hierarchically organised (tree like) data model data objects have parent-child relations. A hierarchically structured data structure is typically such that a plurality of possible child data objects are hierarchically dependent from a “main” or parent object in a tree like structure. A child object may form sub-groups such that a child may parent a plurality of further child objects. An example of the hierarchically organised data file structures is the XML (extended Mark-up Language) file or any other file that is created based on the Standard Generalised Mark-up Language (SGML) format.

In a hierarchically arranged data structure a failure object forms the parent object of a hierarchically structured data model generated for a failure. Since there are typically a plurality of possible causes for a failure, the parent object has a plurality of child objects presenting the possibilities. The possibilities are referred to in the following as hypotheses. Each of the hypotheses in turn may parent a plurality of child objects. These are referred to herein as symptoms. The symptoms represent abnormal changes in the process operation conditions, which lead to a failure in the problem domain (e.g. process and/or its operation and/or equipment and/or component).

An operator of a facility may wish to analyse what was the root cause of a failure. Conventionally the analysis is made so that the operator examines the hierarchically organised data structure displayed to him/her by a display device. The examination of the possible root cause is then made in the direction:
failure→hypothesis→symptoms.

The operator has to select a hypothesis before being able to get a display of the symptoms of that hypothesis. The displayed symptoms then form a checklist for the operator. The operator may need to check each of the symptoms to find the actual root cause for the failure or other deviation from normal operating conditions. The operator also needs to make intelligent guesses to be able to select a likely (preferably the most likely) hypothesis. The operator may also need to go through a number of the hypothesis and the associated symptoms or even all of the hypotheses and the symptoms thereof before being able to determine the actual root cause for the fault. This may take a substantial amount of time.

The currently used computerised analysis systems offer automated analysis in a substantially sequential order of hypotheses one by one. The user has to click many times starting from the choice of observed failure from a number of failure tree options. The user needs to manually select by clicking the hypothesis he believes are the cause of the event, and thereafter check all symptoms for the selected hypothesis. If it turns out that the selected hypothesis is not the correct one, i.e. not the root cause of the problem, the user has to start the procedure again with and select the another hypothesis.

The inventors have found that there is a need for a solution that accelerates the analysis for finding the initial cause of an event such as the source of a problem or other abnormality. The user might find analysis that possesses the power of quick deduction under uncertain or incomplete data useful as this would assist in provision of quick guidance for a failure analyst.

### SUMMARY OF THE INVENTION

Embodiments of the present invention aim to address one or several of the above problems.

According to one aspect of the present invention, there is provided a method of providing data for root cause analysis, the method comprising: transferring data from a structured data model into a causally oriented data model; and complementing the causally oriented data model with information associated with conditional probabilities between at least two objects of the causally oriented data model.

According to another aspect of the present invention there is provided a translator engine for provision of data for root cause analysis, the translator engine comprising translator means for transferring data from a structured data model into a causally oriented data model and processor means for complementing the causally oriented data model with information associated with conditional probabilities between at least two objects of the causally oriented data model.

According to another aspect of the present invention a method of analysing a facility comprises the steps of providing data for the analysis by transferring data that associates with the facility from a structured data model into a causally oriented data model and by complementing the causally oriented data model with information associated with conditional probabilities between at least two objects of the causally oriented data model, and simultaneously analysing at least two root cause hypotheses based on the complemented causally oriented data model.

According to another aspect of the present invention an analyser arrangement for analysing a facility comprises an analyser and data means for provision of data for the analyser, wherein the data means are arranged to transfer data that associates with the facility from a structured data model into a causally oriented data model and to complement the causally oriented data model with information associated with conditional probabilities between at least two objects of the causally oriented data model, and the analyser is arranged to simultaneously analyse at least two root cause hypotheses based on said complemented causally oriented data model.

At least a part of the data for the analysis may be provided from a remote data storage means. The data storage means may be shared by a plurality of users.

According to another aspect of the present invention a data signal is provided for input into a root cause analysis, the data signal being for signalling a causally oriented data model that has been created by transferring data from a structured data model into a causally oriented data model and complementing the causally oriented data model with information associated with conditional probabilities between at least two objects of the causally oriented data model.

A portable user device is also provided for use in control of a facility, the user device comprising means for presenting to a user results of a root cause analysis performed based on a causally oriented data model that has been created by transferring data from a structured data model into a causally oriented data model and by complementing the causally oriented data model with information associated with conditional probabilities between at least two objects of the causally oriented data model.

In addition to generating information regarding events that have already occurred, the causally oriented data models and the analysis may be used for prediction purposes such as for simulation of impacts an action taken by an operator may have before any real action is taken.

In a more specific form the structured data model comprises a hierarchically structured data model. The structured data model may include an event object that has at least one child object, each child object including information of hypothesis associated with possible root causes of the event and said child objects may have further child objects including information associated with symptoms of said possible causes.

Data may be mapped from a structured data model to a causally oriented data model based on causality links between objects of the structured data model.

The causally oriented data model may comprise a graphical model. The completed causally oriented data model may comprise a Bayesian Network. The completion of the causally oriented data model may be based on information associated with the causality relations of the objects. The completed model may comprise at least one conditional probability table.

The embodiments may assist in provision of a substantially fast operator guidance. A data model may be generated based on hierarchically organised data that enables a failure analysis that is not necessarily limited to only one possible root cause. The data model generation may be an automated or a semi-automated process. A list of root causes may be ranked after probabilities whereby a substantially quick and flexible decision support may be provided.

Some of the embodiments enable collection and utilisation of accumulated information about expertise and experience within a problem domain. When tuned by such information the analysis may then reflect some new relations in the problem domain and become more objective. The generated data models reflecting also accumulated knowledge may be processed by a computerised normative system utilising Bayesian Inference.

A further advantage may be obtained in that a computerised system that is adapted to use accumulated knowledge is non-forgetting, a behaviour that may sometimes be a problem with human operators, especially when under stress or critical conditions. Accumulated knowledge may also be independent of circumstances that may be perceived as critical by a human operator.

### BRIEF DESCRIPTION OF DRAWINGS

For better understanding of the present invention, reference will now be made by way of example to the accompanying drawings in which:

FIG. 1 is a schematic presentation showing a control system;

FIG. 2 is a block chart for an embodiment of the present invention;

FIG. 3 is a flowchart in accordance with an embodiment;

FIG. 4 is a block chart showing use of a Bayesian scheme for root cause analysis;

FIG. 5 shows a hierarchically structured data model;

FIGS. 6 and 7 show causally oriented data models generated in accordance with the principles of the present invention;

FIG. 8 shows a graphical user interface that may be presented for a user;

FIGS. 9 to 15 relate to a practical example illustrating the operation of the invention; and

FIGS. 16 to 18 show further embodiments.

### DESCRIPTION OF PREFERRED EMBODIMENTS OF THE INVENTION

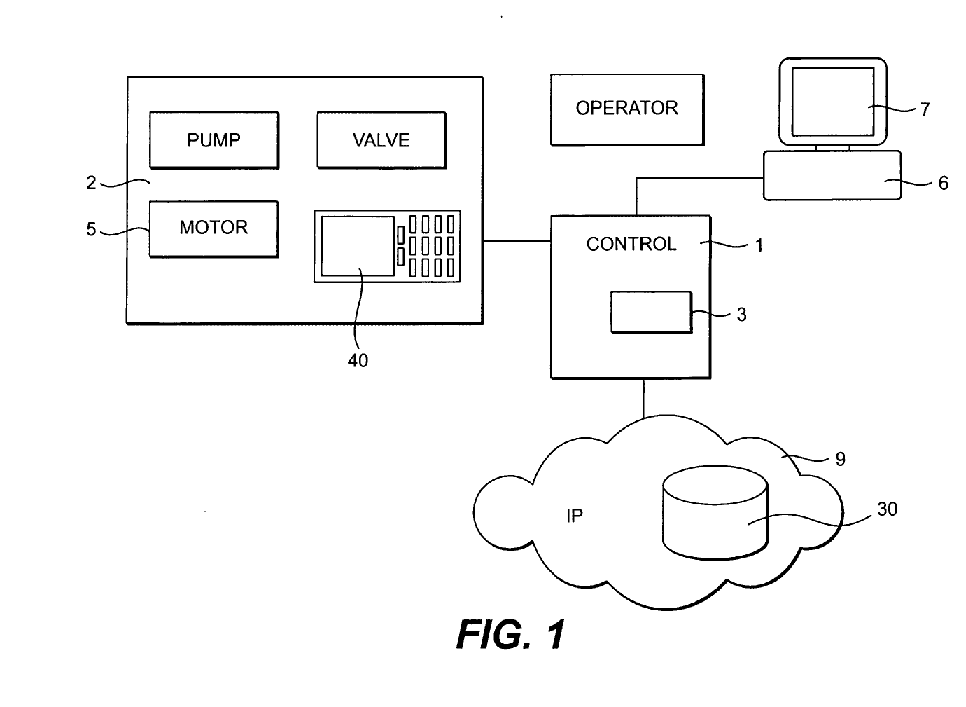

Reference is first made to FIG. 1 which shows a schematic view of a control system 1 adapted to monitor and control operation of a facility indicated by block 2. Since the facility as such does not form an essential element of the invention, it shall not be described in any greater detail. It is sufficient to note that a facility may comprise a plurality of entities 5. The facility may comprise any facility such as an industrial facility (e.g. a plant, factory or a part of a plant or factory), a municipal facility, an office, a building or other construction, and so on.

A computerised control system may be used for controlling various facilities comprising different functional entities and/or processes. The control system 1 comprises a data processor entity that may be adapted for processing data based on object oriented data processing techniques. Examples of object oriented technologies, without being limited to these, include known programming languages such as C++ or Java.

A user terminal 6 is for provision of e.g. an operator with a user interface. The user terminal 6 is connected to the control system 1 by means of an appropriate communication link. The user terminal 6 is provided with display means 7 adapted for providing the user with a graphical user interface (GUI). Although not shown, the user terminal may also be provided with interface means such as a keyboard, a touch screen, a mouse and other auxiliary devices.

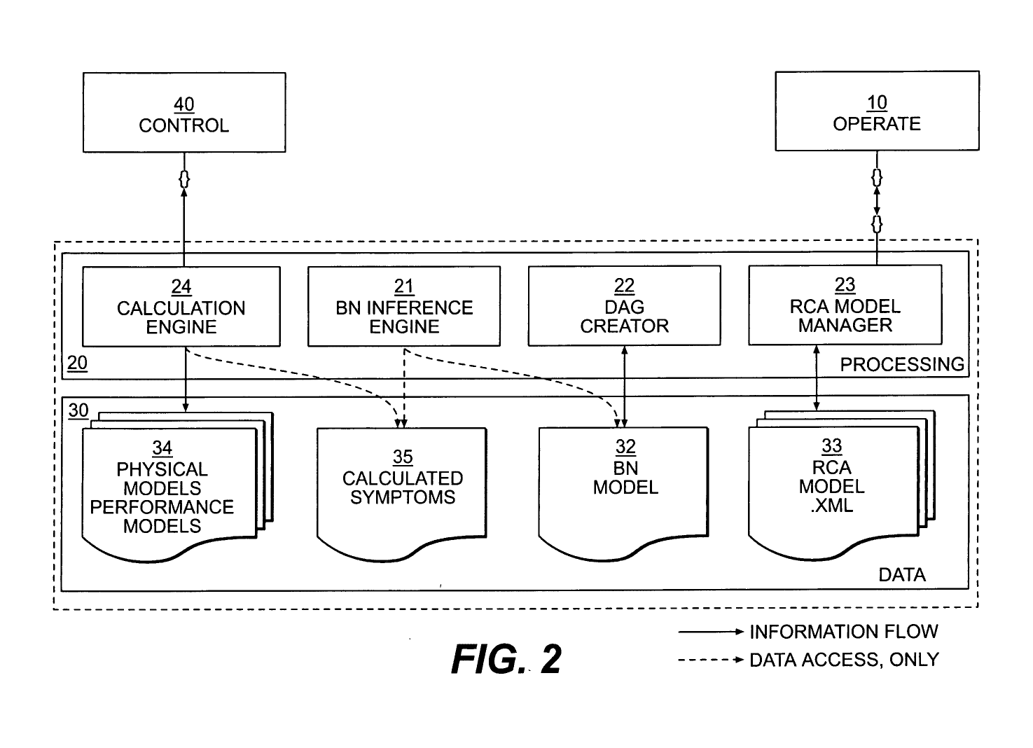

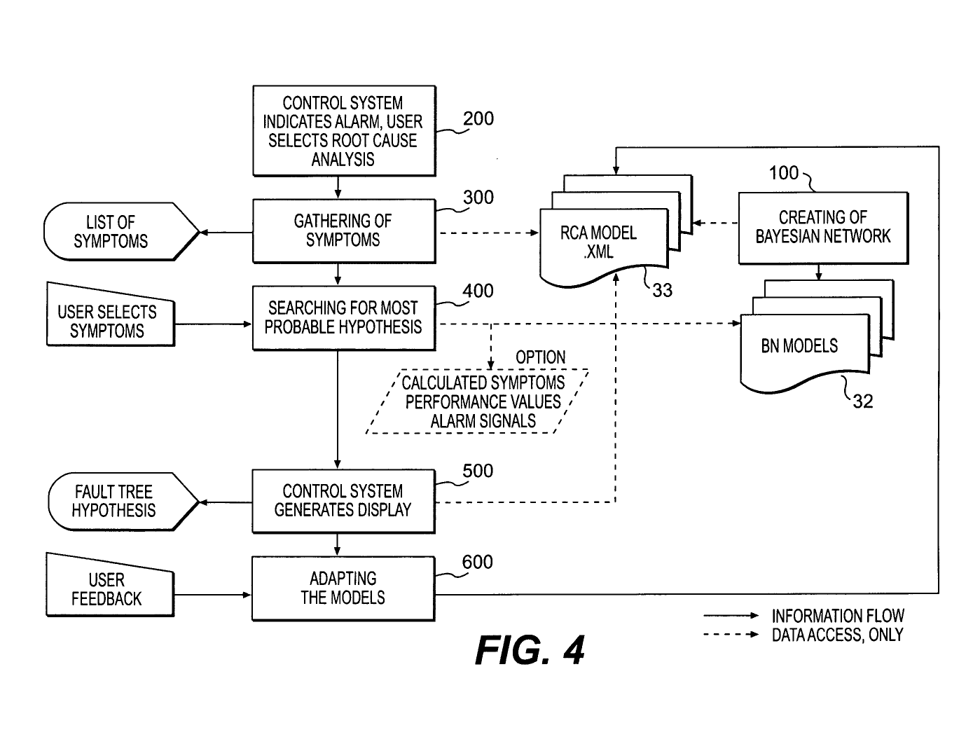

An analyser function 3 of the control system 1 may analyse the facility 2 based on data stored in a database 30. The database will be described in more detail later with reference to FIGS. 2 and 4. Data for the analysis may be fetched via a data communication network such as the IP (the Internet Protocol) based Internet or an intranet or a local area network (LAN).

In FIG. 1 the database is shown as being implemented in an IP based data network environment 9. The control system 1 may then access the database 30 via the network 9. The data communication network may provide packet switched data communication.

However, it shall be appreciated that the database can also be located locally. For example, the data base can be provided in connection with the control system 1.

The analyser function 3 is adapted to provide automated simultaneous verification of several root cause hypotheses. The skilled person is familiar with the basic principles of the root cause analysis. As proposed by its name the root cause analysis can be used for determining root causes of problems. Removal of a determined root cause should also remove the origin of the problem behind an observed effect or failure. The root cause analysis may be used e.g. in a maintenance troubleshooting for anticipation and regulation of systemic causes of maintenance and/or process control problems, in finding the optimal sequence of maintenance and/or control actions, and for asset and/or process optimisation.

Before explaining in detail generation of causally oriented data models based on hierarchically structured data models, an analyser arrangement wherein the analysis may be processed based on causally oriented data models will be described with reference to FIG. 2.

FIG. 2 is a schematic diagram showing an analyser arrangement. The analyser arrangement can be seen as being divided between different hierarchical layers. An inference processing module 20 is implemented in a processing layer of the analyser arrangement. The inference processing module 20 comprises functional entities that are referred to herein as a root cause analysis (RCA) model manager 23, a directed acyclic graph (DAG) creator 22 and a Bayesian network (BN) inference engine 21.

The BN inference engine 21 is adapted to produce reasoning under uncertain and/or incomplete data on possible root causes of a failure or other abnormality based on evidences entered as symptoms in the RCA model manager 23. The inference engine 21 is arranged to perform a simultaneous verification of a number of root cause hypothesis. The simultaneous processing of the hypothesis can be facilitated by use of causally oriented graphical models. A causally oriented graphical model can be described as being a combination of probability theory and graph theory. The causally oriented models can be seen as models that are oriented based on causal associations the various nodes of the model may have with each other.

A database 30 is implemented in a data layer. The database may be for storing the hierarchically structured data models 33 (e.g. an XML file) and the causally oriented data models 32 (e.g. a graphical BN model) that are generated based on the hierarchically structured model 33.

A feature of a causally oriented model is that it contains information regarding the so called chain causalities. The chain causalities allow identification of the possible root causes of a failure. The causality also allows simulations of possible consequences of interventions e.g. by an operator to a process. The causally oriented graphical model is also sometimes referred to as a generative model or a Bayesian/belief network (BN).

A causal directed graphical model is typically built of discrete and continuous decision nodes or objects. The graphical structure of the model is based on assembly of root cause and effect nodes “connected” by the causality links. The causality links present probability potentials. That is, an causality link from node or object A to B can be seen as indicating that A is likely with some certainty to “cause” B. The causality links are sometimes referred to as ‘arcs’. The causality links may be based on appropriate probabilistic methods.

The input for the discrete nodes can be classified into different states. In substantially simple applications parameters such as binary states or intervals of typical parameter variations can be used. The input in the continuous decision nodes can be any type of random variable distribution. For example, Gaussian distribution or superposition of several Gaussian distributions may be used to approximate any continuous distribution.

Conditional probability distribution (CPD) may be assigned for each node of the graphical model to complement the structure thereof. If the variables are discrete, the distribution can be represented by means of a conditional probability table (CPT) with respect to the parents of the node. The table lists the probabilities a child node has on each of its different value for each combination of values of the parent node thereof. The conditional probability tables provide information regarding the relations between the variables thereby allowing probabilistic reasoning under uncertainties. More particularly, a conditional probability table expresses causality relations in terms of conditional probabilities between the child node (e.g. observed/measured/calculated symptom or effect) and its parent nodes (e.g. the causes or conditions causing changes in the child node states).

The conditional probability tables can be created automatically or manually by defining expressions for causality relations between the different variables. The tables may also be generated based on existing expertise and/or data regarding the facility such as statistical and/or physical models, on experience (e.g. on the operator belief on causality) and so on.

The skilled person is familiar with the principles of a causally oriented graphical model or Bayesian Network (BN) and the elements of a Bayesian system for data learning, adaptation, tuning and automated hypothesis verification, and these are therefore not explained in more detail herein. Those interested can finds a more detailed description of the directed graphical models and conditional probability distribution e.g. from an article ‘An introduction to graphical models’ by Kevin P. Murphy, 10 May 2001 or from a book “Bayesian networks and Decision Graphs” by Finn Jensen, Aalborg University, Denmark, January 2001.

Returning now to FIG. 2, the RCA model manager 23 facilitates browsing, searching and filtering of root cause analysis model library 33 stored in the database 30. The RCA model manager 23 may also be used by the operator or another failure analyst to enter observed and/or measured symptoms of the problem domain into the analyser system.

The root cause model library 33 of the database 30 is for storing hierarchically structured root cause analysis models. These models are stored in a selected format wherein the data is arranged in a logical or structured order. The models may advantageously be stored in the XML format. However, as explained above, the Inventor has found that this format may not always be the best suitable data model for the analysis.

A example of data structure that can be more readily processed by the Bayesian network (BN) inference engine 21 is the so called directed acyclic graph. The directed acyclic graph (DAG) creator 22 is arranged to translate the RCA model stored in a hierarchical data structure into a directed acyclic graph (DAG).

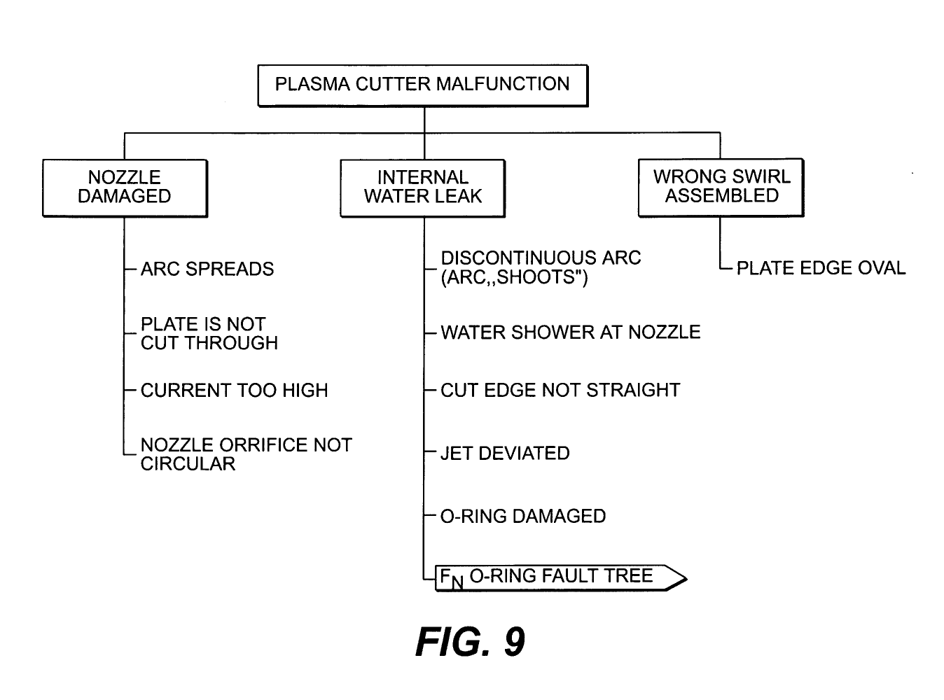

The directed acyclic graph (DAG) creator 22 may be provided with a functionality such as a XML parser for the translation of the XML model structure into a data structure referred to as a directed acyclic graph (DAG). A practical example illustrating the operation of a XML parser is described later with reference to FIGS. 9 to 15.

The various entities of the processing layer may access additional information via an interface element 10 of a control module 40. The control module 40 may comprise an automated functionality for controlling a facility. It may be integrated with an operate module 10 to provide a user interface for operators. The control and operate modules may be provide in a common control platform.

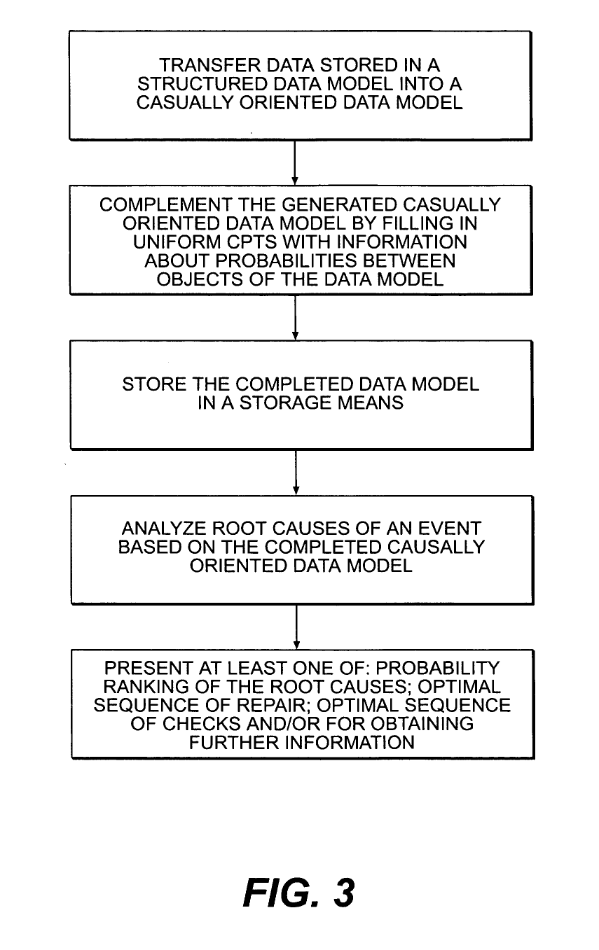

As shown by FIG. 3, the initial causally oriented data model needs to be complemented based on additional information. That is, a completed BN model needs to be generated based on said directed acyclic graph (DAG). The completion may be based on quantitative information from another type of structured data associated with conditional probability distributions between at least two objects. To provide this the completed BN model may comprise at least one conditional probability table that associates with the generated graph. The completion of the directed acyclic graph by at least one conditional probability table can be seen as an operation that corresponds to filling the uniform CPTs with typical values of conditional probabilities for a certain state of a child (effect) object under the condition ( of certain states of the parent (cause) object(s). These typical values of conditional probabilities represent the conditional distributions for the discrete or continuous random variables (=nodes i.e. objects) in the BN.

Alternatively expressions may be defined, said expressions representing the conditional probability distribution of variables i.e. objects in the causally oriented data model.

The completion may be accomplished by an expert or automatically by filling in the conditional probability tables with probability values. An expert (process engineer and/or operator) of the problem domain may be a person who supplies the failure frequencies (recalculated to prior probability) and ranked weightings of the possible root causes (recalculated to root cause probabilities). The obtained probabilities may be transferred by means of an appropriate program code means (e.g. Visual Basic™) into the Bayesian network (BN) in order to complete the CPTs and thus provide the default probability setting in the Bayesian model library, before evidences are propagated through the BN (and as a result of the inference the root cause probabilities are updated). The automatic filling may be accomplished by statistical processing of database information related to failure frequencies in the problem domain. The probability values may be based e.g. on statistics of the problem domain such as the frequency of the failure or a database of representative earlier cases for the same failure type. The values may also be based on operator expertise on the problem domain, on operator's beliefs and/or experience on the probabilities and so on.

A more detailed example of the generation of the causally oriented graph and completion thereof by the conditional probability tables to obtain a BN data model will be explained in more detail later.

Completed BN models may be stored in a library of BN models 32 for later use by the inference engine 21. The BN inference engine 21 may fetch an appropriate BN model 32 from the library. The selection of the required model can be done automatically from the Bayesian Model library based on observed failure and problem domain.

The inference engine 21 may also access evidences automatically from a control system such as a distributed control system (DCS). The operator may also input evidences. The evidences may be propagated through the BN model 32 to produce a guidance list with ranking of most probable root causes and a list providing an optimal sequence of control, operation and/or maintenance actions.

FIG. 4 shows a scheme for automated simultaneous verification of several root cause hypotheses based on Bayesian technology. More particularly, a possible way of performing a fixed Bayesian scheme for root cause analysis is shown. As in FIG. 3, the first step comprises translation of a hierarchical XML data structure through XML parsers into a directed acyclic graph (DAG). The DAG contains for each causality link of the graph a uniform conditional probability table which will then be filled in i.e. completed (if necessary) with probability values that are representative of the particular problem domain to build a BN model for root cause analysis.

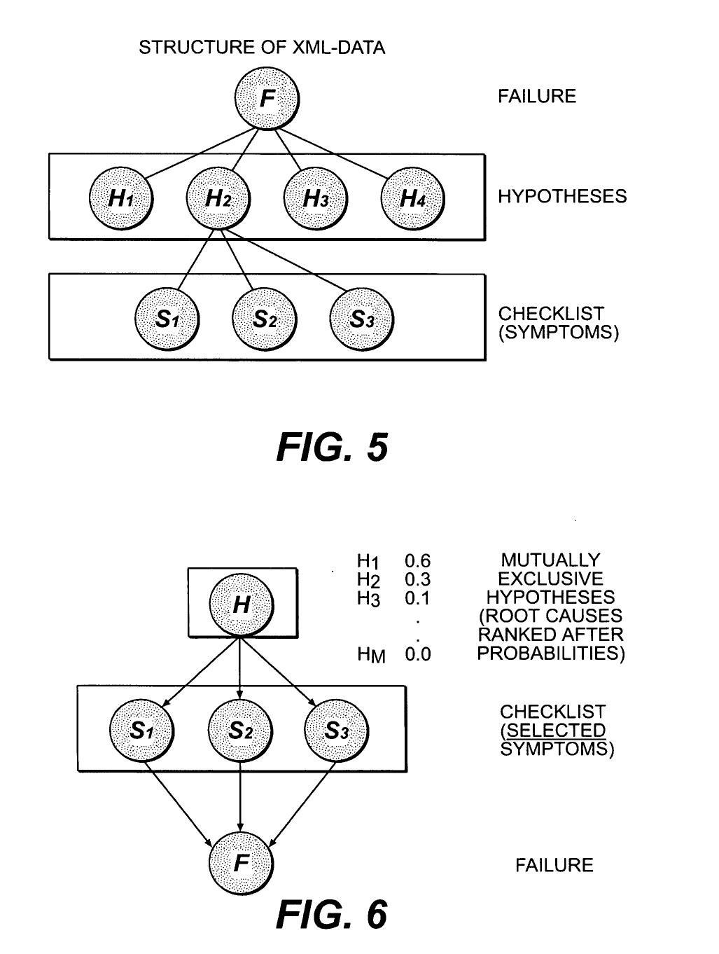

Before explaining the analysis process of FIG. 4 in more detail, a reference is made to FIGS. 5 to 7 showing in more detail hierarchical and causally oriented data structures.

FIG. 5 illustrates an hierarchical data structure that may be stored in the storage 33. The hierarchical data structure may comprise an extended mark-up language i.e. XML data structure. The hierarchical structure may be parented by a failure node or object F. The hypothesis form child nodes H1 to H4 of the failure object F. Each of he hypothesis objects H1 to H4 in turn has child nodes S referred to as symptom objects. It shall be appreciated that two or several of the hypothesis nodes H1 to H4 may parent similar symptom objects.

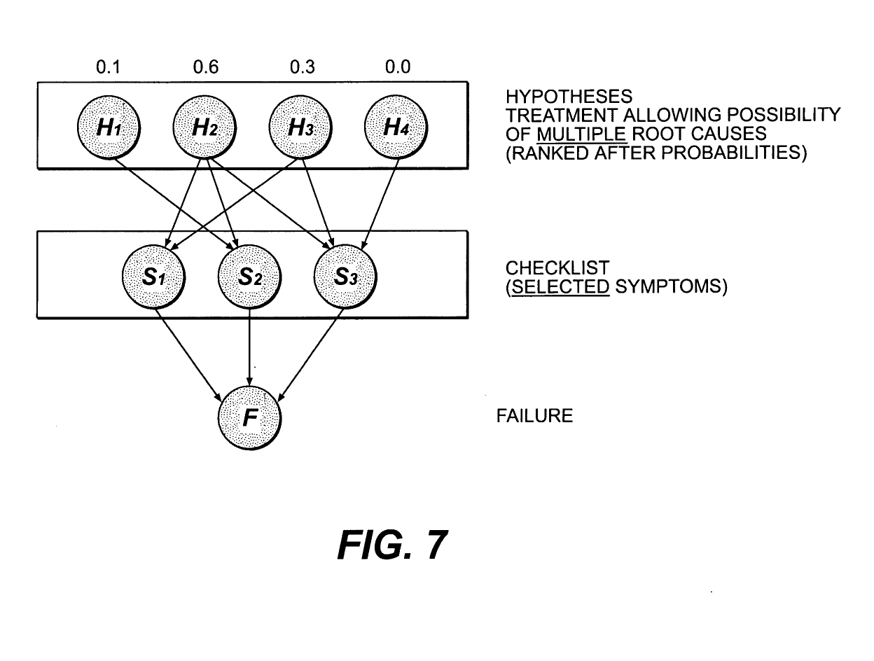

The causality links of a causally oriented graphical data model are, in turn, oriented from cause to effect. FIGS. 6 and 7 show two different types of causally oriented graphical data models into which the hierarchical structure of XML-data of FIG. 5 can be translated. The causally oriented data models are referred to herein as BN models.

More particularly, FIG. 6 shows a BN structure wherein a single fault is assumed to have occurred in facility that was working normally until the detection of a failure or abnormality. The single fault assumption is thus represented by a single root cause node with mutually exclusive states. In FIG. 6 each of the mutually exclusive hypothesis of the one hypothesis node H has been assigned with a weight according to the probability of each of the hypothesis H1 to Hn. FIG. 7 shows a BN structure for multiple causes of an observed failure. The mutually non-exclusive multiple root causes are ranked after probabilities as shown on top of each hypothesis node H1 to H4. Each of the hypothesis nodes H1 to H4 is given a weight in accordance with the probability thereof. The causality chain in both of these the causally oriented data structures is:
root cause→symptoms→failure

The probability of the hypotheses i.e. possible root causes may be updated each time the inference engine receives new evidences on the set of symptoms.

As shown by FIG. 5, the hierarchically organised data is stored in the form of a fault tree. The tree may include hypotheses on possible root causes and corresponding checklists (lists of symptoms). The inventors have found that the hierarchical failure tree can be mapped into a BN model. An example of the translation is described below assuming that the XML hierarchical data of FIG. 5 has the following structure:

Failure

Hypothesis 1

Check point 1.1
. . .
Check point 1.n

Hypothesis k

Check point k.1
. . .
Check point k.m

The inventors have found that this structure may be transferred to a DAG such that a failure from the XML model is mapped into an observed effect failure node in the BN model. The check points of the XML model (i.e. the symptoms) are mapped into symptom nodes of the BN model. However, the XML structure does not contain explicitly any causal links. Instead, the XML data is organised in hierarchical levels, where each failure level contains a number of hypothesis sub-levels and each hypothesis sub-level contains as sub-sub-levels a number of checkpoints. These XML hierarchical level-sublevel-sublevel structure, however, can be mapped into causality links (root cause→symptom; symptom→failure) in the BN graph. This can be seen as corresponding to assignment of default CPTs with uniform probability on the corresponding states of all observed symptoms and effects. In accordance with an embodiment the creation of a BN model from a hierarchical failure tree includes three different mapping stages. These will be described below.

The symptom nodes of the BN graph can be of different character. For example, discrete nodes with mutually exclusive states may be provided. The exclusive states may be binary (=Boolean) states such as “yes” (=“true”) when a symptom is observed and “no” (=“false”) when a symptom is not observed. The states may also indicate other features such as the intervals of the symptoms, relative symptoms levels (e.g. the ratio between measured value at an observation time point and value of the last set point) and so on. If a single fault is assumed to have occurred (FIG. 6), the states may also represent mutually exclusive types of failures for the same object. For example, a node “plate cut quality” may be provided with states: “OK”, “OVAL”, “CUT NOT STRAIGHT”, “CUT NOT THROUGH”. Continuous nodes may represent continuous random variables with defined statistical distributions, like Gaussian (normal) conditional distribution or superposition of Gaussian distributions.

Several nodes for the states at consequent time points may be used to incorporate symptom trends into the analysis. For example, a trend can be determined based on changes in the symptoms at different time points.

Hypotheses of the XML tree are then mapped into root cause nodes of the BN graph. The mapping of the XML hypotheses into the root cause nodes can be accomplished in different manners depending on the type of the failure (single or multiple causes).

A single cause of a failure can be represented by one root cause node, see FIG. 6. The one BN node may have states that are mutually exclusive hypotheses. The main assumption for applying the single fault modelling approach is that everything was properly functioning before the failure was observed. The list of mutually exclusive hypothesis may include a hypothesis ‘normal’ (i.e. no fault).

Multiple root causes of a failure can also be represented by binary nodes with states “yes” and “no” for each hypothesis, see FIG. 7. More than two states may also be used. For example, intervals or trends of the possible cause development can be used as classification criteria.

The next possible mapping stage comprises mapping of the relations of the hierarchically organised X data structure between the checkpoints and the hypothesis into causality links of the BN graph. The mapping of the causality directions from cause to effect is important for the correct translation of the causality links (expressing dependency relations), which is crucial for the reasoning, i.e. propagation of evidences by the inference engine.

If several hypothesis share the same symptoms, several causality links may then lead from those hypothesis to the same shared symptoms. The mapping will allow creation of causality links within the same parent/child XML structure. The orientation of the links will be defined by the mapping from hypothesis (root cause)→to check points (symptoms)→failure.

An XML model does not contain quantitative data on failure frequencies or statistics, and therefore the XML data does not allow filling of the CPTs with the proper probability values for the corresponding problem domain. The quantitative information on failure frequencies can be filled in another type of file (e.g. into a spreadsheet such as an EXEL-arc). The other type of file may also contain information regarding the probabilities of the problem domain. The obtained probabilities may be transferred into the CPTs (replacing/updating the uniform/initial default values) in order to complete/update the DAG and to obtain the completed BN model. The transfer may be accomplished by means of another program code (e.g. Visual Basic).

Under the assumption of a single fault (FIG. 6), the number of the hypothesis is mapped into one root cause node of the BN model with the same number of mutually exclusive states representing the number of hypothesis. An extra state may be used for allowing the possibility of no fault or another fault hypothesis than those already listed.

To incorporate the possibility of multiple faults (FIG. 7), the number of hypothesis from the XML model may be mapped into the same number of root cause nodes in the BN model with Boolean states. Again, an extra root cause node may be employed for the possibility of another fault hypothesis than those already listed.

It shall be appreciated that FIGS. 6 and 7 present only simple BN models and do not show presence of possible causality relations between the different symptoms and/or presence of intermediate causes as effects of the root cause. If causality relations exist between the symptoms the models may be modified to take this into account by adding appropriate causality arrows and the associated conditional probability tables (CPTs). The causality arrows shall be understood as being graphical object that present the conditional probability tables.

Returning now to FIG. 4, BN models are first created based on the RCA models stored at the data storage 33, step 100. More particularly, a Bayesian Network (BN) model comprising a directed acyclic graph (DAG) is created from XML data models. An initial BN graph i.e. a directed acyclic graph (DAG) may be created off-line from a RCA model by the DAG generator 22 of FIG. 2. The directed acyclic graph structure is then completed with at least one conditional probability table (CPT) to build a completed BN model for the diagnostics.

A complete BN model can be created for each fault. A BN model preferably includes all hypotheses on possible root causes of a failure and/or abnormality. A simultaneous evaluation of all hypothesis can be done by supplying to the inference engine 21 only once all evidences on acquired symptoms from the problem domain. If new evidences are required and supplied later on, all hypothesis are again evaluated simultaneously to provide quick update of the list with root cause ranking. Thus, an on-line adaptive learning functionality of the system can be provided. In the conventional arrangements such simultaneous processing is not possible. Instead, evidences relevant to a single hypothesis need to be supplied and evaluated separately from similar processing of other hypothesis.

According to a possibility, if several faults share a big number of similar symptoms, one BN model can be generated for simultaneous hypothesis verification on the root causes of several failures and/or abnormalities.

A complete BN data model reflects the hierarchical structure of a hierarchically arranged data structure of the corresponding RCA model 33. If the hierarchical XML data structure does not exactly include the right order of causality directions (as is the case in FIG. 5), proper causalities can be incorporated into the BN model during the translation procedure.

The BN models are preferably generated and stored in the BN model library when the analysis system is developed. That is, step 100 of FIG. 4 may be performed off-line and the BN models for the root cause analysis (RCA) are stored in a database such that the created BN data models can be accessed later on by the analyser entity. The off-line generation of the BN models may save time later on if BN models for a corresponding problem domain are needed. Another advantage of the beforehand generated BN models is that the search may be executed directly on the most probable root causes without requirement for any translations between the two different data structures before the analysis.

At step 200 the control system gives a fault alarm to the operator. The operator decides to use root cause analysis (RCA) to analyse the fault. To initiate the analysis the operator selects appropriate function by means of the user interface of the analysis system, e.g. by the user terminal 6 of FIG. 1. The root cause analysis can also be triggered automatically e.g. in response to a Distributed Control System (DCS) alarm.

The control system may gather evidences i.e. symptoms of the fault at step 300 by loading a corresponding RCA model 33 through the RCA model manager 23. The gathering of evidences may occur simultaneously with the selection of the root cause analysis (RCA) at step 200. The step of gathering may comprise classification of evidence signals gathered as symptoms and additional information provided. Discrete evidences may be classified into different states and/or variation intervals. Evidences that are of continuous type may be classified into mean and standard deviation (or variance) classes. The classification is preferably accomplished in real-time. The classification function may be included in the root cause analyser 3 or in the control system 1 of FIG. 1. In the latter case the classified signals may be transferred as real-time evidences to the analyser. The symptoms i.e. the evidences can be propagated through the Bayesian network that is searching for the most probable root causes of the observed fault.

The list of symptoms may be completed by operator inputs. At least a part of the symptoms may be provided by sources such as the monitoring functions of the control system. For example, information about the symptoms may be provided by measuring instrument means such as temperature, pressure or moisture sensors, or information gathering means such as video cameras, microphones, smell sensors (artificial noses, gas sensors), microphones and so on. The list of symptoms may be provided automatically by utilisation of control system functionalities such as measurements, calculations or other monitoring parameters which are entered as evidences on the state of symptom nodes. At least a part of the symptoms may be provided manually by the operator in the beginning of the root cause analysis or later as additional evidences to the automatically supplied evidences from the control system.

The list of evidences can be completed by automatic computations by appropriate models describing the system, such as performance models and/or physical and/or statistical models. Use of the additional evidences may make the reasoning procedure more accurate.

A simultaneous hypothesis verification (step 400 ) can be performed after the information in the BN model has become available for the analyser. The analysing step determines a weight for each of the possible hypothesis based on the probability thereof, the simultaneous verification being for determining the most probable root cause of a failure. The BN model 32 may be accessed on-line at step 400, for example via a local data network or an IP based data network 9 of FIG. 1. The simultaneous verification of more than one hypothesis provides savings in time as compared to the prior art where all hypotheses had to be checked one after the other. Thus, significantly quicker fault isolation may be obtained.

Searching for the possible root causes of a failure can be seen as a diagnostic application of the BN model. The probabilistic reasoning in diagnostic applications is performed in direction opposite to the causality links. That is, the inference engine 21 may calculate the probable root causes (hypotheses) starting from the observed failure and then from symptoms without being forced to select the hypotheses first. In addition, the causality structure of the network allows examination of the impact of intended interventions, which can be very useful for control of complex processes in order to examine operation actions, which might have unwanted or dangerous consequences.

At step 500, a ranking of possible root causes is displayed for operator. The obtained root causes may be ranked based on their probabilities before being presented to the operators and/or maintenance personnel. This may be used to provide improved operator guidance and decision support on control and/or maintenance activities.

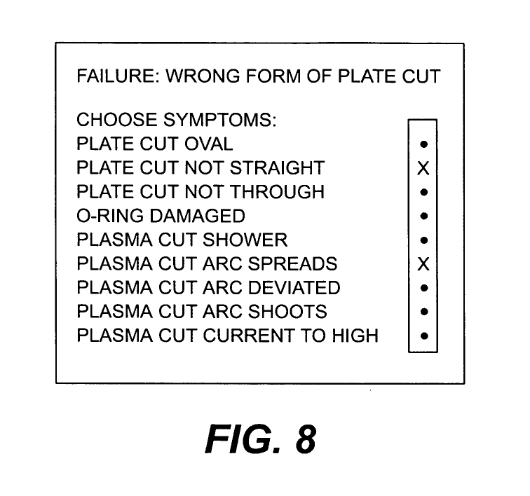

The operator may be presented with a list of representative symptoms for a fault domain. The operator may then choose from the presented list the observed/measured symptoms of the fault. FIG. 8 shows an example of such a list. The list relates to a cutting process for steel industry. In this example an alarm signal ‘wrong form of plate cut’ is given by the control system. After the operator has selected root cause analysis the operator is presented with a Graphical User Interface (GUI) for selecting the observed symptoms.

The operator may select all observed or measured symptoms from the symptom list of a failure indicated to him/her as an alarm. The combination of the selected symptoms may then be entered as evidence to the Bayesian inference engine 21 for the hypothesis verification to produce a list of possible root causes. The mapping may be accomplished by the DAG creator 22. This is done by mapping the object of FIG. 5 into the data model of FIG. 6 (single fault assumption) or FIG. 7 (multiple faults possibility).

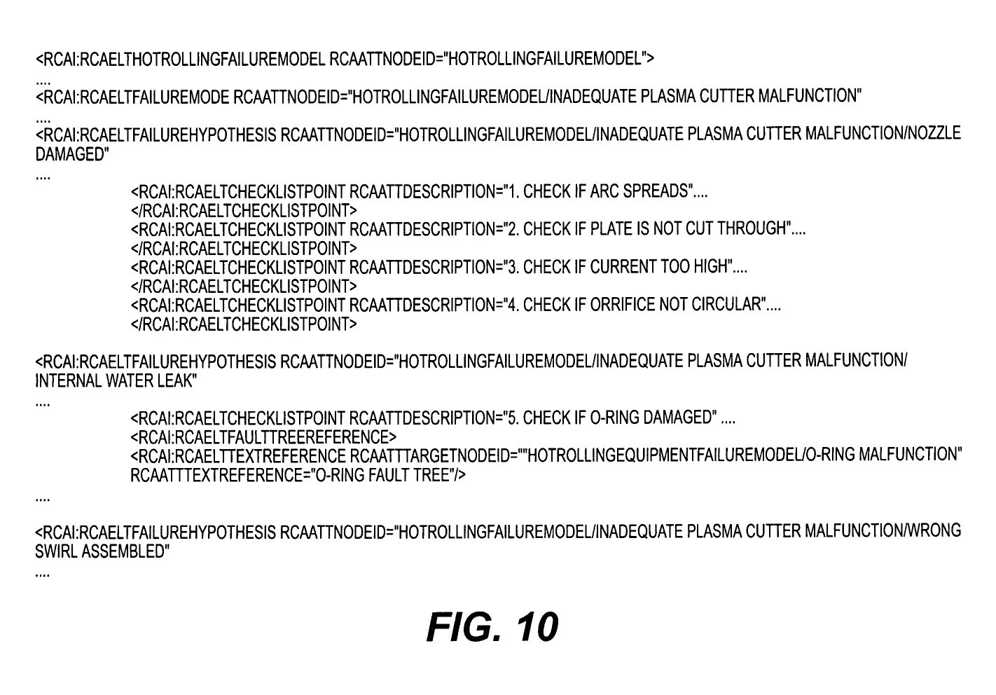

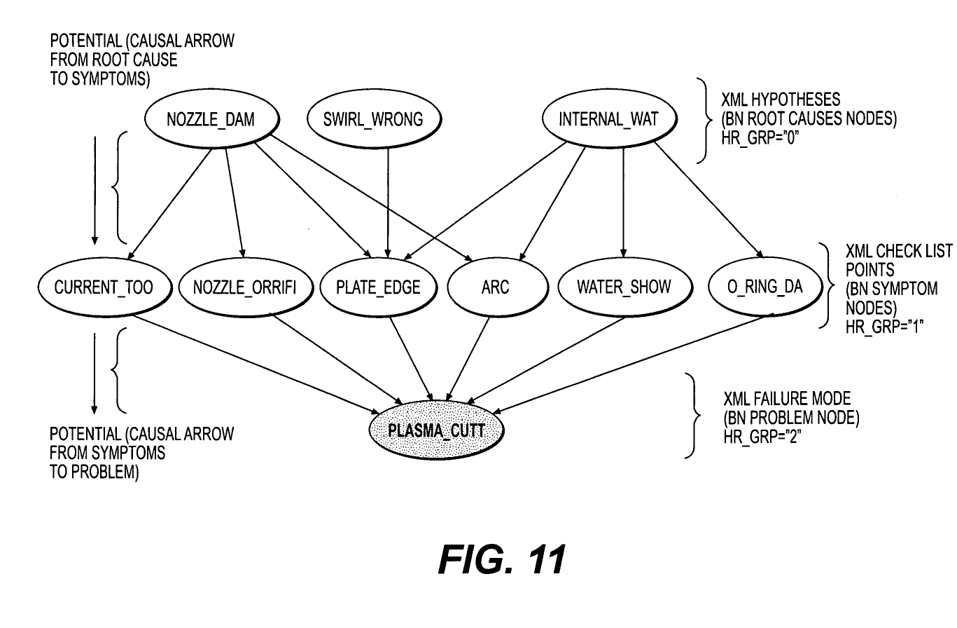

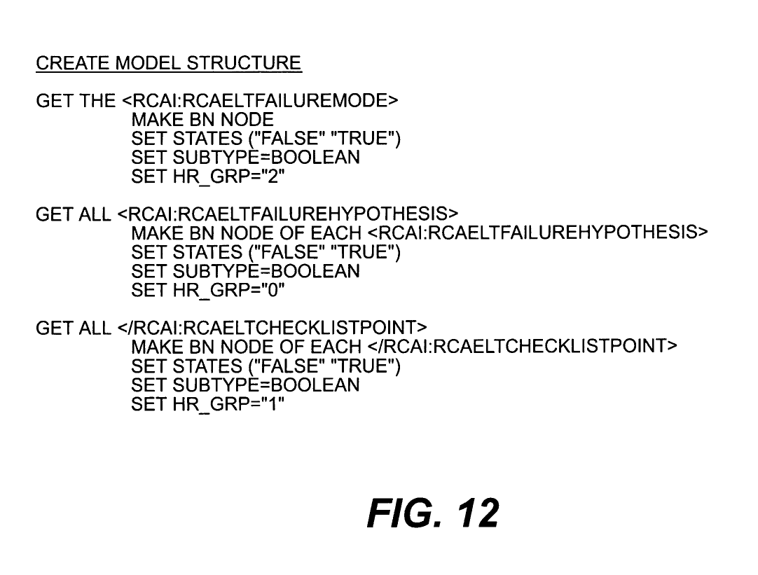

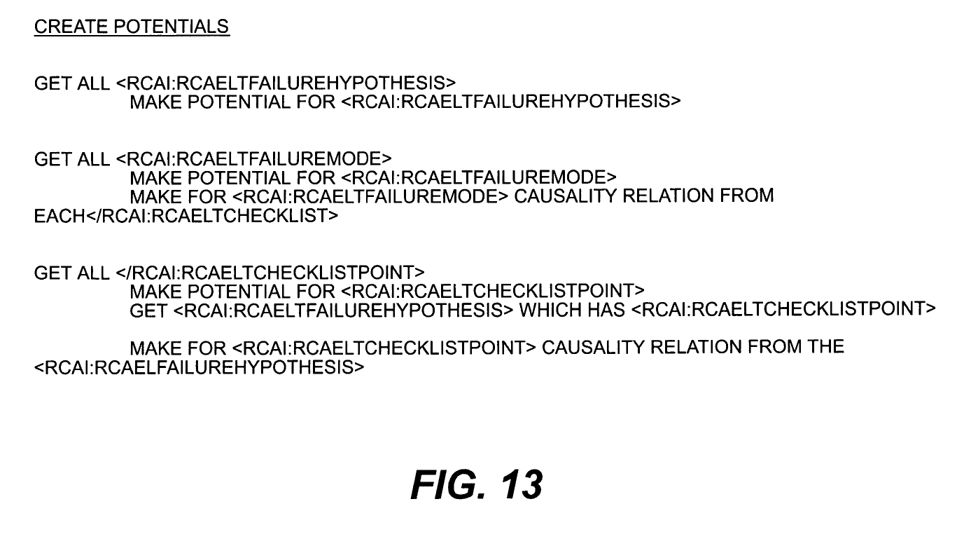

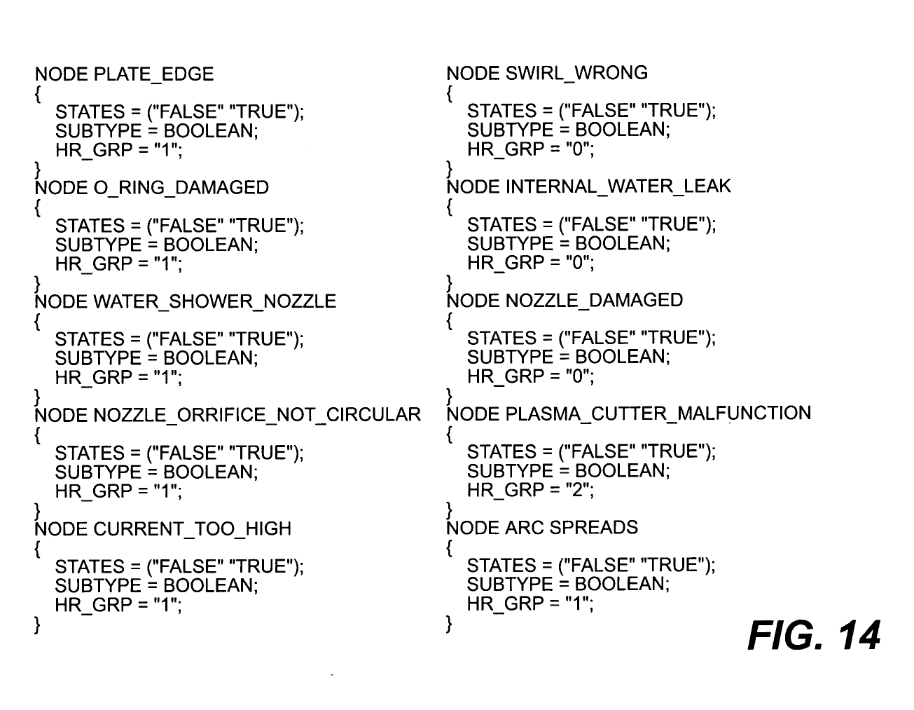

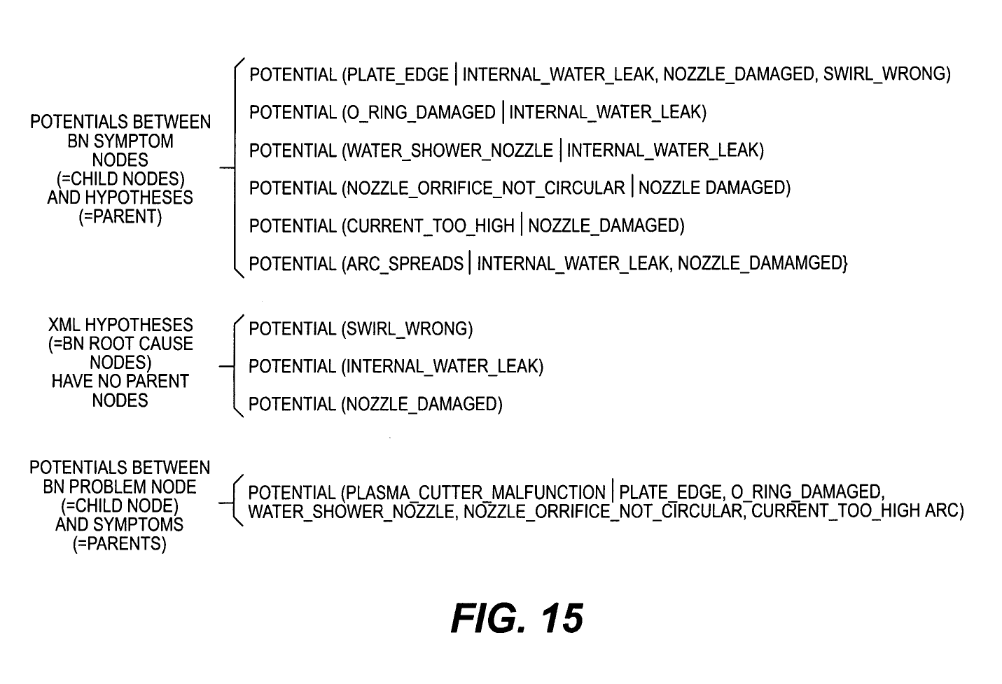

A concrete example of the generation of causally oriented data model based on XML data for a plasma cutter malfunction is now described with reference to FIGS. 9 to 15. The hierarchical failure tree is shown by FIG. 9. FIG. 10 shows the XML data structure for the root cause analysis for the plasma cutter malfunction. FIG. 11 shows the BN model generated by means of a XML parser for use in root cause analysis. FIG. 12 shows the mapping rules for generation of the BN model of FIG. 11. FIG. 13 shows the mapping rules for generation of the BN potentials i.e. model causality. The potentials in BN model are defining conditional causality relations between child and parent objects i.e. symptoms (=check points) and root causes (=hypothesis) and between failures (=e.g. a plasma cutter malfunction) and symptoms (=check points). FIG. 14 shows the actual code for the BN model of FIG. 11. FIG. 15 shows the code for the BN model causality.

The above discusses provision of an automated creation of the causally oriented acyclic BN graphs directly from the existing hierarchical data structures and an analysis based on the causally oriented data model. The analysis may also comprise some other stages in addition to the above described.

According to a further embodiment the BN models may be updated during the use of the analysis system. For example, the analysis may be made adaptive to enable user feedback. The adaptive analysis based on the Bayesian Scheme may be improved even further by means of combined evidences. The adaptive scheme and the combined evidences may be advantageously used for provision of improved results of the analysis. Completion of the conditional probability distributions can be provided by means of manual or automatic update of the information base. The automated update can be utilised in provision of a learning system that is adaptive to e.g. changes in the process, equipment and/or operation conditions.

Adaptive analysis may be provided by updating the BN model with new symptoms, new root causes and changes in the CPTs. The update may be accomplished e.g. based on operator feedback at the end of an analysis and/or by tuning the BN with failure cases representing the problem domain. If adaptive BN analysis scheme is used the operator may be provided with explanation through highlighting the chain of causality in the fault trees. This may be accomplished in a plurality of ways. For example, different colours, blinking elements or animated elements and so on may be displayed on a display screen. This may make it easier for the operator to understand the system and make him/her more confident with the system.

It is also possible to collect operator feedback on system conclusions, new symptoms or changes in the CPT. These all are useful in provision of an adaptive system. The original BN model incorporates default probabilities between causes (hypotheses on possible root causes) and effects (observed or measured symptoms). Adaptivity that is based on operator feedback and changes in causality relations (of the same DAG) may be realised through update of the CPTs, e.g. by adding experience counts and fading factors.

The proposed diagnostic system may be integrated as an aspect of an object in a platform of a control system that is adapted for object oriented data processing. Object oriented programming techniques or languages were developed to ease incorporation or integration of new applications in a computerised system. A data object may represent any real life object or entity such as, without being limited to these, a device or a component of a device, a cell, a line, a meter, a sensor, a sub-system, a controller, a user and so on. An aim of the object oriented techniques is to break a task down to smaller autonomous entities that are enabled to work together to provide the needed functionality. These entities are called objects.

During development of a set of control instructions or control software based on the object oriented techniques the designer may determine what objects are needed for the instructions and the interrelations each of the chosen objects has with other objects. When the control program is run a functionality of the program may call an object that is stored e.g. in a database of the control system. A feature of the object oriented methods is that an object can be called and located by the name of the object.

An object may have different aspects, each aspect defining more precisely features such as a characteristic and/or function and/or other information associated with the object. That is, an object may associate with one or more different aspects that represent different facets of the entity that the object represents. An aspect may provide a piece of the functionality of the object. An aspect may be either exclusive or shared by several objects. An object may also inherit an aspect from another object. The different facets of a real world object may comprise features such as its physical location, the current stage in a process, a control function, an operator interaction, a simulation model, some documentation about the object, and so on. The facets may be each described as different aspects of a composite object. A composite object is a container for one or more such aspects. Thus, a composite object is not an object in the traditional meaning of object-oriented systems, but rather a container of references to such traditional objects, which implement the different aspects. Typically the composite object would be a software object representing a real world entity.

International publication No. WO 01/02953 entitled “Method of integrating an application in a computerised system” is a more detailed description of a method to represent real world entities in a computerised system. In such a method and system, different types of information about the real world entity may be obtained, linked to the real world entity, processed, displayed, acted on, and so on. An application that may be used to provide some function of real world entity defines interfaces that are independent of the implementation of the application itself. These interfaces may be used by other applications, implementing other aspects or groups of aspects of a composite object. The WO publication No. 01/02953 describes also a method in which a software application can query a meta object such as an object representing a real world entity (entity object) for a function associated with one of its aspects. A reference to the interface that implements the requested function can then be obtained through the entity object. In the present invention at least some features of the diagnostic system may be integrated as an aspect of an object in the control system platform and/or accessible to the control system.

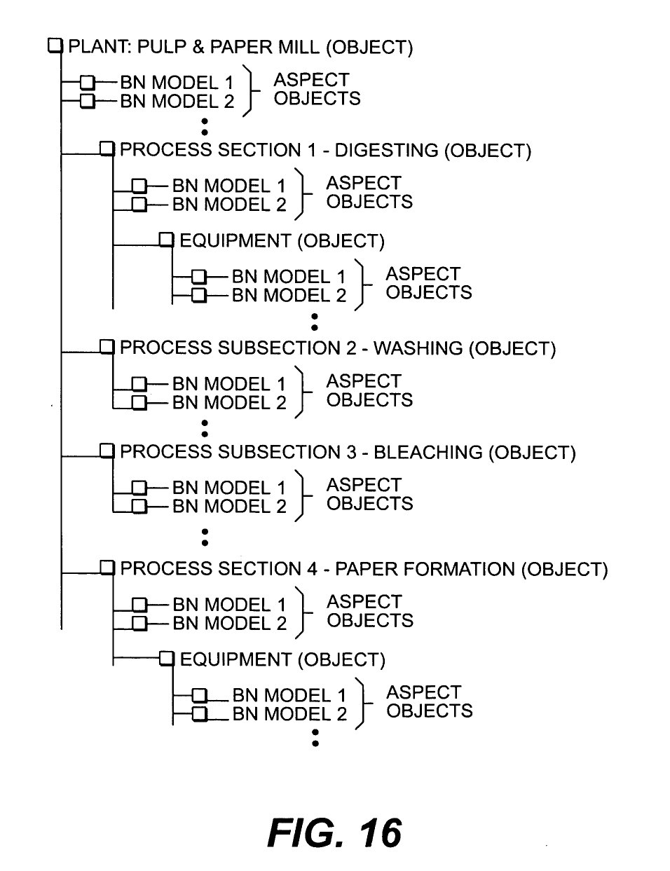

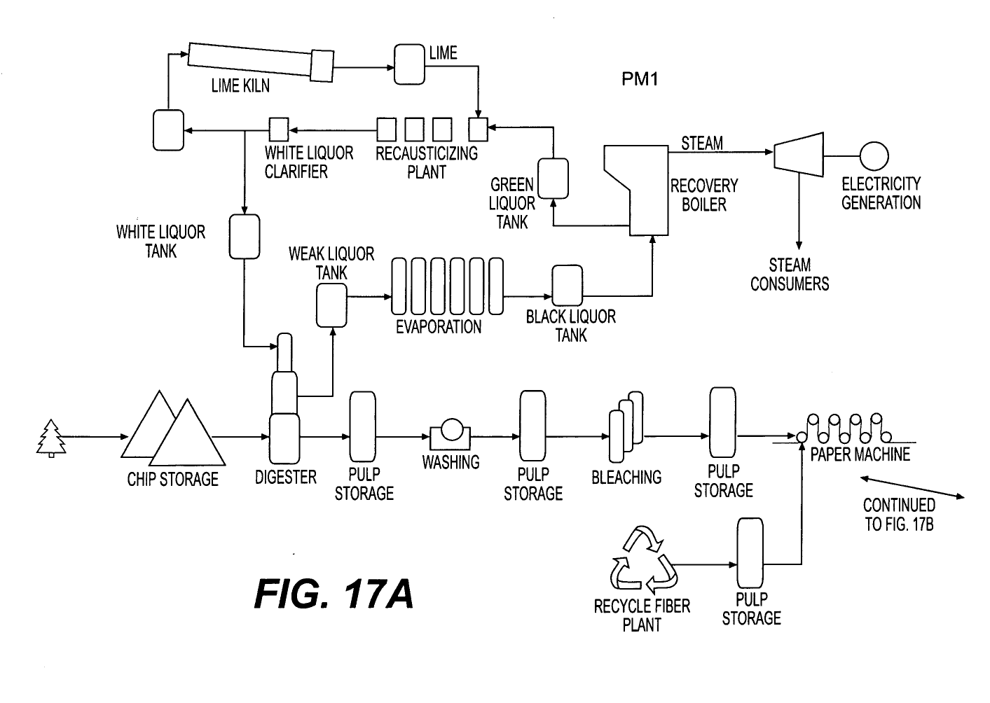

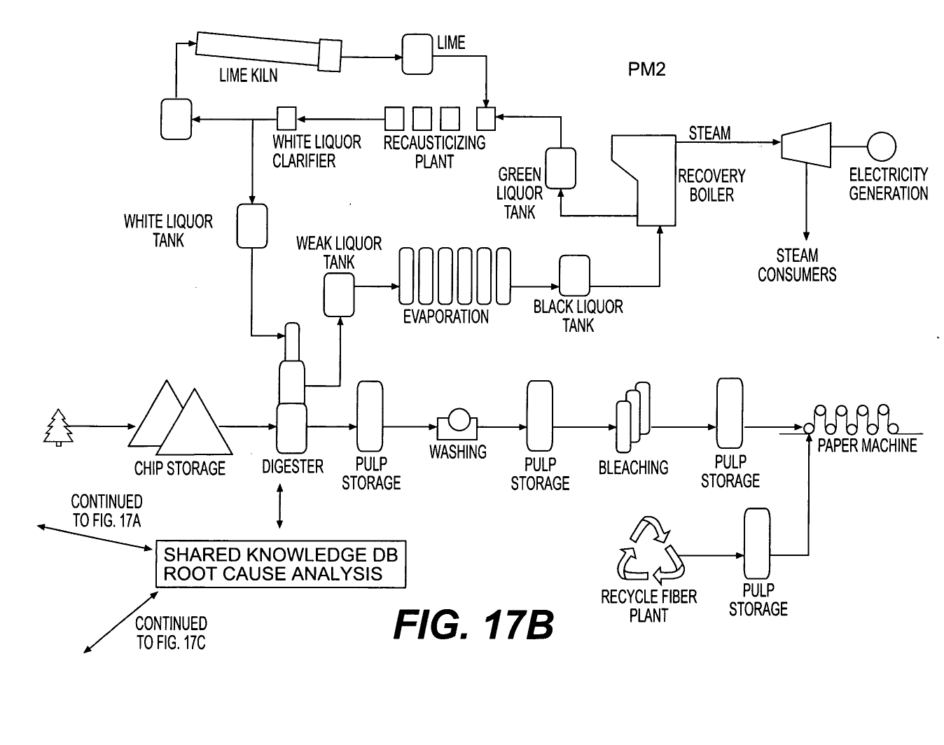

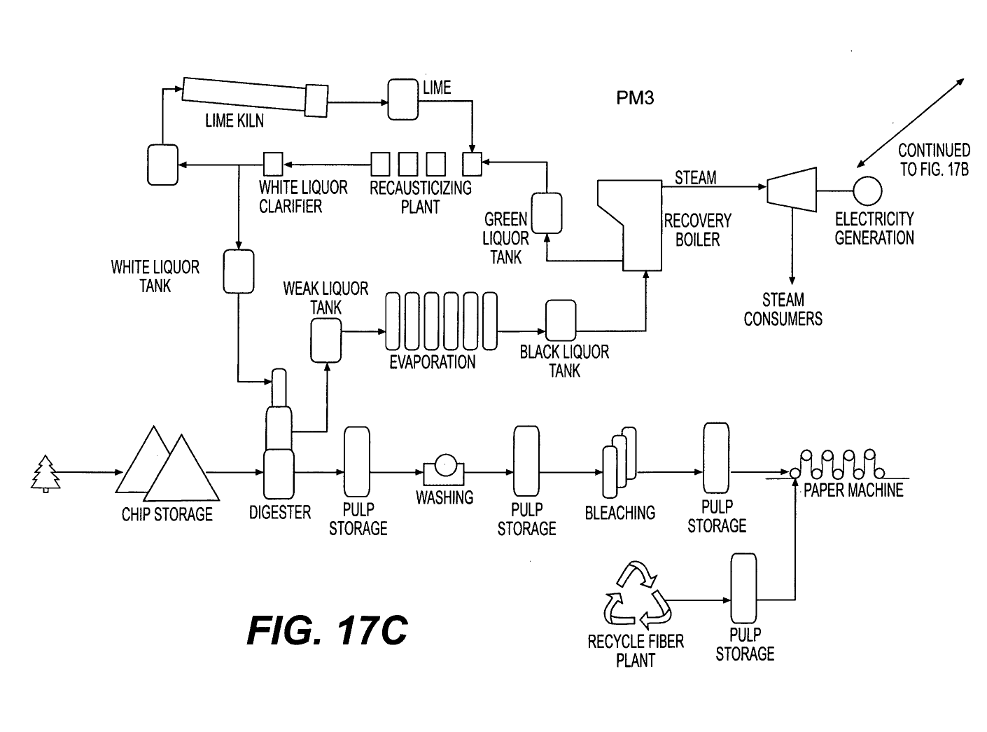

FIG. 16 shows possible real world objects and the associated BN models for a continuous process such as for any of the paper mills PM1 to PM3 of FIG. 17. The BN models are integrated as aspect objects in a model describing the entire process such as a pulp and paper mill. Each process stage (e.g. Digesting, Washing, Bleaching, Recycling, Paper Formation, Evaporation, Recovery & Recaustisizing) can be modelled separately and included as an object aspect in the P&P Mill model.

According to a further embodiment the analysis system and/or data models for an analysis can be accessed through a data network, for example through the Internet or an Intranet or other data network operating in accordance with the internet protocol (IP). The process operators of maintenance personnel may be enabled to speed up the analysis of the root causes of problems, or confirm their own diagnosis in critical control actions by accessing a remote database via the data network. The remote database may include a number of components. Each component may be used for root cause analysis of different, but related failure or other problems. As shown by FIG. 17, a shared database 31 may be provided wherein an individual organisation such as individual factories anonymously store data regarding failures, malfunctions, problems and so on. In FIG. 16 example the individual factories are shown to comprise paper mills PM1 to PM3. This enables creation of an extensive statistical database with cases representing domain applications and their typical or chronicle problems.

The shared database 31 provides several advantages. The database is broadened enabling the analysis system to fine tune and complete its structure. All customers may benefit from the improving system since an organisation may apply data learned from other organisations the to their own production. An Internet based system may be accessible for only those customers who have subscribed to it. An Intranet system of an organisation may be a global system including tens or hundreds of remote facilities.

The remote database 31 may be provided by an independent service provider. To avoid misuse of the system for example for competitor fraud attempts for example by intentionally manipulated incorrect data or by non-consistent data, the Bayesian technology may be used to provide a data conflict analysis to identify, trace or resolve possible conflicts in the acquired observations. By certain double check procedures for data acquisition, a sensitivity analysis on the parameter observations can be performed.

According to a possible implementation the shared database is accessible over the Internet (See FIG. 1) or over a network such as a LAN or an intranet. A dedicated web site for one or more databases may be established according to the known art of providing web sites. In most cases the web site will include access and log-in processes suited to different types of users and to users carrying out different tasks. Log-in procedures and means to provide them are well known to those skilled in the art of providing web sites. When an information provision and/or data fetching system is established, for example, a first type of log-in is provided so that the operator can select and specify information such as technical requirements, matching schemes, reporting destinations and requirements, reporting format, reporting media, normal and exception reporting measures, contract type and billing details. Subsequent log-ins may then be used by an operator to update or alter configuration aspects such as reporting requirements, dial-up phone number and so on.

A second type of log-in may be provided for access by the analysis system to the database for fetching at least one BN model. There may be more than one type of log-in process for the second type of log-in according to a predetermined access mode and, for example, degree of security and or validation required by the owner or operator of the system.

It shall be appreciated that the proposed solution for transformation of hierarchically organised data models to causally oriented data models can also be employed by a stand alone systems.

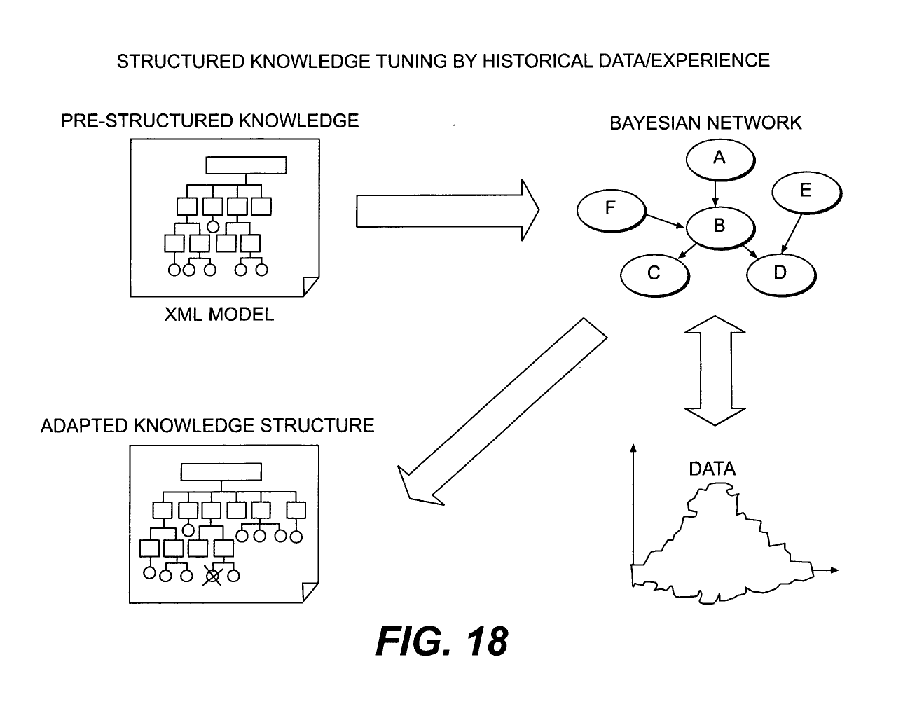

FIG. 18 shows a still further embodiment of the present invention wherein the BN model is tuned based on historical data and/or experience after creation thereof. This results in an adapted knowledge data structure as shown in the lower left hand corner of FIG. 18. As can be seen some of the root causes are determined as being of minor importance and are shown to be crossed out from the adapted knowledge data structure, and will be ignored in any future analysis.

The tuning may be based on any data. The tuning by data or experience will update the BN model and extract conditional probabilities for decision support. Operator feedback may function as fine tuning in the procedure of automating the creation of the BN model.

A still further embodiment is described with reference to FIG. 1. An industrial process or other facility may contain a number of manually operated devices 5 (such as valves, switches, gears and so on). The manually operated devices may be located substantially far away from the operator's workstation 6. Because of this there may from time to time exist a need for a tool for helping the operator e.g. to input the symptoms in the root cause analysis system at the spot, that is whenever he/she feels it necessary to provide such information to the system.

To improve the chances that correct information is input in a substantially real-time manner into the system the operator may be provided with a portable device 40. The device may communicate with the control system 1 and/or the analysis system 3 via a wireless interface.

The portable device 40 may comprise a display or other user interface (e.g. one based on voice messages, indicator lights and so on) for representing a ranked list of possible causes and the optimal sequence of repair actions or any other actions the operator could take. The display may also present an optimised path how to walk or otherwise move around in the plant, or an optimised time after which a check needs to be made on those local instruments which are not sending automatic input to the control system 1. In addition, an optimal sequence of actions and so on may be presented to the operator until the source of the failure or abnormality is found and removed.

The portable device 40 may also include input means, such as control buttons and/or a touch screen. The input means allow the operator to enter new evidences after manual inspection of symptoms or devices, remotely execute an update of the root cause analysis resulting in an updated list of root causes.

The embodiments of the invention may be employed, for example, in a diagnostic arrangement which exploits a probability based approach for reasoning under uncertainties in an analysis system providing root cause analysis.

The proposed analysis system may provide a quick and flexible troubleshooting and/or predictive diagnostics tool for operators of complex systems. The benefits may include reduced breakdown times, increased productivity and efficiency of the system under control. The solution may be applied to any industrial facility or other complex facility. For example, but without being limited to these, the solution can be used by industrial facilities of metal, foundry, pulp, paper, cement, minerals, chemical, oil, gas and other petrochemicals, refining, pharmaceuticals, food and beverage, automotive industries, automatic storage and/or handling systems (e.g. freight handling systems) and so on. The solution may be used in association with new equipment/systems or existing systems.

Use of existing hierarchically organised data provides several advantages. For example, the creation of the initial BN graphs can be done automatically (i.e. without intervention by the user) which saves development time. Use of data that already exist in a hierarchically organised data structure may also reduce significantly the engineering efforts on transferring the collected domain knowledge and operator experience that is obtained e.g. through interviews on the plant into BN compatible graphs.

A further advantage is provided by the possibility to easily add new failure symptoms into the existing hierarchically organised data. This can be realised through a user interface to the data structure that allows user feedback for automated update of the existing data models after the step 500 of FIG. 4. This approach allows flexibility for adaptive learning on-line of the updated cause-effect relations resulting in updated BN graphs.

Simultaneous verification of a plurality of hypothesis is a feasible solution since all observed symptoms can be entered as one set of evidences in a single BN model. For example, a evidence vector containing only numeric values of evinces could be propagated through a BN model. All hypotheses for a certain failure may have been built into said BN model (see the BN models of FIGS. 6 and 7). This may allow higher computational effectiveness. The simultaneous hypothesis verification may speed up considerably the troubleshooting e.g. in a complex industrial facility.

A further advantage provided by the use of causal networks lies in the causality itself which allows, in addition to monitoring, diagnostic, and troubleshooting, simulation of the impact of an operator intervention before any real action is performed. This may be crucial e.g. when the consequences of certain operator actions may be undesired e.g. for safety or economic reasons. The predictive character of the symptoms may also enable analysis based on which it is possible to take necessary corrective actions before any actual failure or other deviation from optimal operation conditions occurs.

The root cause analysis may be used especially advantageously in systems wherein substantially complex causality processes of failure and/or abnormality may build up, for example in the process of paper making illustrated in FIG. 17. The root cause analysis tool may also be advantageously employed in analysing components, devices, equipment and/or systems comprising both hardware and software components. The above proposed solutions shorten the time required for searching a fault substantially relative to the time wherein a search is done without an automated system for creation of the data for the analysis. This may lead to reduction in the costs related to failures and/or abnormalities and other events in a process, equipment, devices, components and so on. Time consumed by unplanned process stops, production losses, losses due to wrong production parameters and poor quality, unnecessary consumption of materials and energy may provide significant advantages. The system also may be used for reducing operation and maintenance costs, manpower costs for failure searching and so on. Therefore the overall productivity and efficiency of a facility may be increased by means of the above proposed embodiment.

It is noted herein that while the above describes exemplifying embodiments of the invention, there are several variations and modifications which may be made to the disclosed solution without departing from the scope of the present invention as defined in the appended claims.

1. A method of providing data for root cause analysis, the method comprising:
transferring data from a structured data model into a causally oriented data model; and
complementing the causally oriented data model with information associated with conditional probabilities between at least two objects of the causally oriented data model.

2. The method according to claim 1, wherein the structured data model comprises a hierarchically structured data model.

3. The method according to claim 1, wherein the structured data model includes an event object that has at least one child object, each child object including information of hypothesis associated with possible root causes of the event and said child objects have further child objects including information associated with symptoms of said possible causes.

4. The method according to claim 1, wherein said data transfer comprises mapping of data from the structured data model to the causally oriented data model based on causality links between objects of the structured data model.

5. The method according to claim 1, wherein in the causally oriented data model a hypothesis object refers to at least one symptom object and said at least one symptom object refers to an event object.

6. The method according to claim 1, wherein the structured data model contains data regarding hypothesis and symptoms of the hypotheses, the method comprising mapping of the symptoms in the structured data model into symptom objects of the causally oriented data model, mapping of the hypotheses of the structured data model into root cause objects of the causally oriented data model and mapping of the relations between the symptoms and the hypothesis into causality links of the causally oriented data model.

7. The method according to claim 6, wherein the causality links are mapped in the direction from cause to effect.

8. The method according to claim 1, wherein the causally oriented data model comprises a graphical model.

9. The method according to claim 8, wherein the graphical model comprises a directed acyclic graph.

10. The method according to claim 1, wherein the completed causally oriented data model comprises a Bayesian Network.

11. The method according to claim 1, wherein the hierarchically structured data model comprises an extended mark-up language (XML) file.

12. The method according to claim 1, wherein the completion of the causally oriented data model is based on information associated with the causality relations of the objects.

13. The method according to claim 1, wherein said information comprises quantitative information from another type of structured data associated with conditional probability distributions between at least two objects.

14. The method according to claim 1, wherein the conditional probabilities are between symptom objects and root cause objects of the causally oriented data model.

15. The method according to claim 1, wherein the causally oriented data model is completed by at least one conditional probability table.

16. The method according to claim 15, wherein the conditional probability tables are generated based on knowledge about the subject of the analysis and/or information about previous failures and/or failure frequencies that are characteristic for the particular problem domain.

17. The method according to claim 15, wherein the completed causally oriented data model is provided by filling in uniform conditional probability tables with probability values.

18. The method according to claim 1, wherein the information associated with the conditional probabilities represents conditional probability distribution of objects in the causally oriented data model.

19. The method according to claim 1, wherein the transfer is accomplished such that the completed causally oriented data model reflects the hierarchical structure of the structured data model.

20. The method according to claim 1, wherein at least two root cause hypotheses are processed simultaneously based on at least one complemented causally oriented data model.

21. The method according to claim 1, comprising transportation of the causally oriented data model via a data network.

22. The method according to claim 21, wherein at least a part of the transportation occurs via internet protocol data communication environment.

23. The method according to claim 1, wherein causally oriented data models are generated and stored in a central storage entity based on information from a plurality of individual sources.

24. A translator engine for provision of data for root cause analysis, the translator engine comprising:
translator means for transferring data from a structured data model into a causally oriented data model; and
processor means for complementing the causally oriented data model with information associated with conditional probabilities between at least two objects of the causally oriented data model.

25. A computer program product comprising program code means for performing the steps of claim 1 when the program is run on a computer.

26. A method of analyzing a facility, comprising:
providing data for the analysis by transferring data that associates with the facility from a structured data model into a causally oriented data model and by complementing the causally oriented data model with information associated with conditional probabilities between at least two objects of the causally oriented data model; and
simultaneously analyzing at least two root cause hypotheses based on the complemented causally oriented data model.

27. The method according to claim 26, further comprising presenting a list of symptoms to a user.

28. The method according to claim 26, wherein the complementing of the causally oriented data model is accomplished adaptively based on updated information regarding the facility to be analysed.

29. The method according to claim 28, wherein said update of said information is automatic.

30. The method according to claim 26, wherein the analysis comprises a search for the most probable cause for an event by means of a Bayesian Network.

31. The method according to claim 26, wherein the hypothesis are ranked in probability order.

32. The method according to claim 31, wherein a user is notified about a change in the ranking of a hypothesis.

33. The method according to claim 26, further comprising transportation of data model via a data communication network.

34. The method according to claim 26, wherein an item of data is transmitted via a wireless interface.

35. The method according to claim 26, wherein observed symptoms are entered into the analysis in one evidence vector.

36. The method according to claim 26, wherein results of the analysis are presented for a user by means of a portable device.

37. The method according to claim 26, comprising presenting instructions to a user based on the analysis by means of user interface device.

38. The method according to claim 26, wherein causally oriented data models are stored as aspects of real world objects in a model describing the facility.

39. An analyzer arrangement for analyzing a facility, comprising an analyzer and data means for provision of data for the analyzer, wherein
the data means are arranged to transfer data that associates with the facility from a structured data model into a causally oriented data model and to complement the causally oriented data model with information associated with conditional probabilities between at least two objects of the causally oriented data model, and
the analyser is arranged to simultaneously analyse at least two root cause hypotheses based on said complemented causally oriented data model.

40. An analyzer arrangement according to claim 39, further comprising a user interface for presenting possible root causes of an event for a user.

41. An analyzer arrangement according to claim 40, the user interface comprising a portable device adapted for communication over a wireless interface.

42. The analyzer arrangement according to claim 39, wherein at least a part of the data form the analysis is provided from a remote data storage means.

43. An analyzer arrangement according to claim 42, wherein the data storage means is shared by a plurality of users.

44. A control system for controlling a facility, comprising an analyzer arrangement according to claim 39.

45. The control system according to claim 44, wherein the causally oriented data models are used for simulation of the impact of an action taken by an operator before any real action is performed.

46. A data signal for input in a root cause analysis, the data signal being for signaling a causally oriented data model that has been created by transferring data from a structured data model into a causally oriented data model and complementing the causally oriented data model with information associated with conditional probabilities between at least two objects of the causally oriented data model.

47. A portable user device for use in control of a facility, the user device comprising means for presenting to a user results of a root cause analysis performed based on a causally oriented data model that has been created by transferring data from a structured data model into a causally oriented data model and by complementing the causally oriented data model with information associated with conditional probabilities between at least two objects of the causally oriented data model.

48. The portable user device according to claim 47, further comprising input means for input of information for use by the root cause analysis.
